(19) United States
(12) Patent Application Publication
(10) Pub. No.: US 2026/0228733 A1
(43) Pub. Date: Aug. 6, 2026

(54) SETTLEMENT PROCESSING DEVICE, BIOMETRIC INFORMATION REGISTRATION DEVICE, INFORMATION PROCESSING SYSTEM, AND SETTLEMENT PROCESSING METHOD

(71) Applicants: NEC Platforms, Ltd., Kanagawa (JP); NEC Corporation, Tokyo (JP)

(72) Inventors: Wakana INOUE, Kanagawa (JP); Tetsuya MIHIRA, Kanagawa (JP); Hiroyuki KAWAMOTO, Kanagawa (JP); Daichi SHIMOHATA, Kanagawa (JP); Ryo HACHIYA, Tokyo (JP)

(73) Assignees: NEC Platforms, Ltd., Kanagawa (JP); NEC Corporation, Tokyo (JP)

(21) Appl. No.: 19/149,890

(22) PCT Filed: Jan. 25, 2023
(86) PCT No.: PCT/JP2023/002242

§ 371 Date: Jul. 22, 2025

(51) Int. Cl. G06Q 20/40; G06Q 20/32

(52) U.S. Cl. CPC G06Q 20/40145; G06Q 20/3278

(57) ABSTRACT

Please delete the Abstract of the Disclosure, and replace it with the following:

The present invention provides a settlement processing device including, a purchase information acquisition unit that acquires information relating to a purchase product to be purchased by a customer, a registered information acquisition unit that acquires registered biometric information, which is biometric authentication information for identifying the customer, and settlement information for the customer to settle the purchase of the purchase product, the biometric information and settlement information being recorded on a medium carried by the customer, a collation information acquisition unit that acquires collation biometric information for verifying the customer at the time of settlement, a collation unit that collates the collation biometric information and the registered biometric information with each other, and a settlement unit that uses the settlement information to settle the purchase product when the registered biometric information and the collation biometric information match each other.

### DESCRIPTION

### Technical Field

The present disclosure relates to a settlement processing device, a biometric information registration device, an information processing system, a settlement processing method, a biometric information registration method, an information processing method, and a recording medium.

### Background Art

There is a settlement apparatus that authenticates a customer by using customer information such as face authentication and performs settlement by using settlement information associated with the customer information, in order to simplify the settlement at a store. For example, PTL 1 discloses an authentication apparatus that stores face feature information of a user and an electronic settlement apparatus that performs face authentication by using a captured image obtained by imaging the user at the time of settlement and determines electronic settlement means of a settlement target in a case where the face authentication is succeeded.

### CITATION LIST

### Patent Literature

PTL 1: WO 2021/186575 A1

### SUMMARY OF INVENTION

### Technical Problem

The technique described in PTL 1 needs to provide face feature information of a user to a store side in advance. However, some customers feel resistant to providing personal information such as the face feature information to a third party such as the store or a settlement agency.

An example of objects of the present disclosure is to provide a settlement processing device that can simplify settlement in a store, without providing personal information to a third party.

### Solution to Problem

A settlement processing device according to one aspect of the present disclosure includes purchase information acquisition means for acquiring information regarding a purchased product purchased by a customer, registration information acquisition means for acquiring registration biometric information that is biometric authentication information used to identify the customer and settlement information used to settle the purchased product by the customer, recorded in a medium carried by the customer, collation information acquisition means for acquiring collation biometric information used to collate the customer at the time of settlement, collation means for collating the registration biometric information with the collation biometric information, and settlement means for performing settlement of the purchased product by using the settlement information, in a case where the registration biometric information and the collation biometric information match.

A biometric information registration device according to one aspect of the present disclosure includes biometric information registration means for registering registration biometric information that is biometric authentication information used to identify a customer, settlement information acquisition means for acquiring settlement information used to settle a purchased product by the customer, generation means for generating code information in which the registration biometric information and the settlement information are embedded, and output means for outputting the code information.

A settlement processing method according to one aspect of the present disclosure performed by a computer, includes acquiring information regarding a purchased product purchased by a customer, acquiring registration biometric information that is biometric authentication information used to identify the customer and settlement information used to settle the purchased product by the customer, recorded in a medium carried by the customer, acquiring collation biometric information used to collate the customer at the time of settlement, collating the registration biometric information with the collation biometric information, and performing settlement of the purchased product by using the settlement information used to settle the purchased product by the customer, in a case where the registration biometric information and the collation biometric information match.

A biometric information registration method according to one aspect of the present disclosure performed by a computer, includes registering registration biometric information that is biometric authentication information used to identify a customer, acquiring settlement information used to settle a purchased product by the customer, generating code information in which the registration biometric information and the settlement information are embedded, and outputting the code information.

An information processing method according to one aspect of the present disclosure performed by a computer, includes registering registration biometric information that is biometric authentication information used to identify a customer, acquiring settlement information used to settle a purchased product by the customer, generating code information in which the registration biometric information and the settlement information are embedded, outputting the code information, acquiring information regarding the purchased product purchased by the customer, acquiring the registration biometric information and the settlement information embedded in the code information, acquiring collation biometric information that is biometric authentication information used to collate the customer at the time of settlement, collating the registration biometric information with the collation biometric information, and performing settlement of the purchased product by using the settlement information embedded in the code information, in a case where the registration biometric information and the collation biometric information match.

A recording medium according to one aspect of the present disclosure, stores a program for causing a computer to execute processing including acquiring information regarding a purchased product purchased by a customer, acquiring registration biometric information that is biometric authentication information used to identify the customer and settlement information used to settle the purchased product by the customer, recorded in a medium carried by the customer, acquiring collation biometric information used to collate the customer at the time of settlement, collating the registration biometric information with the collation biometric information, and performing settlement of the purchased product by using the settlement information used to settle the purchased product by the customer, in a case where the registration biometric information and the collation biometric information match.

A recording medium according to one aspect of the present disclosure stores a program for causing a computer to execute processing including registering registration biometric information that is biometric authentication information used to identify a customer, acquiring settlement information used to settle a purchased product by the customer, generating code information in which the registration biometric information and the settlement information are embedded, and outputting the code information.

A recording medium according to one aspect of the present disclosure stores a program for causing a computer to execute processing including registering registration biometric information that is biometric authentication information used to identify a customer, acquiring settlement information used to settle a purchased product by the customer, generating code information in which the registration biometric information and the settlement information are embedded, outputting the code information, acquiring information regarding the purchased product purchased by the customer, acquiring the registration biometric information and the settlement information embedded in the code information, acquiring collation biometric information that is biometric authentication information used to collate the customer at the time of settlement, collating the registration biometric information with the collation biometric information, and performing settlement of the purchased product by using the settlement information embedded in the code information, in a case where the registration biometric information and the collation biometric information match.

### Advantageous Effects of Invention

According to the present disclosure, it is possible to provide a settlement processing device that can simplify settlement in a store, without providing personal information to a third party.

### BRIEF DESCRIPTION OF DRAWINGS

FIG. 1 is a block diagram illustrating a configuration example of a settlement processing device according to a first example embodiment.

FIG. 2 is a diagram illustrating a hardware configuration of the settlement processing device according to the first example embodiment achieved by a computer device and peripheral devices thereof.

FIG. 3 is a diagram illustrating an example of a configuration of the settlement processing device according to the first example embodiment.

FIG. 4 is a flowchart illustrating an operation of the settlement processing device according to the first example embodiment.

FIG. 5 is a block diagram illustrating a configuration example of an information processing system according to a second example embodiment.

FIG. 6 is a diagram for explaining an example of a biometric information registration device according to the second example embodiment.

FIG. 7 is a flowchart illustrating an operation of information processing according to the second example embodiment.

FIG. 8 is a block diagram illustrating a configuration example of the information processing system according to a modification of the second example embodiment.

### EXAMPLE EMBODIMENT

Hereinafter, example embodiments of a settlement processing device, a biometric information registration device, a settlement processing method, and a non-transitory recording medium recording a program according to the present disclosure will be described in detail, with reference to the drawings. The present example embodiment does not limit the disclosed technology.

### First Example Embodiment

### (Settlement Processing Device 100)

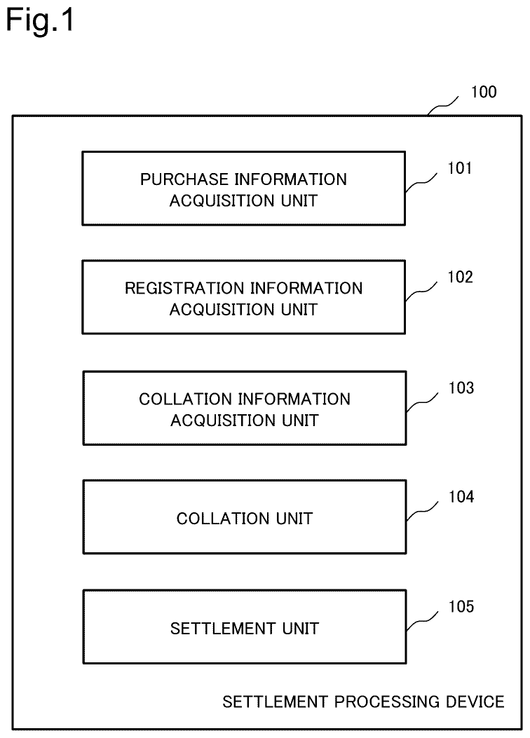

First, a first example embodiment of the present disclosure will be described in detail with reference to the drawings. FIG. 1 is a block diagram illustrating an example of a configuration of a settlement processing device 100 according to the first example embodiment. The settlement processing device 100 is a device for a customer who has shopped in a store to settle a purchased product and is provided, for example, near an exit of the store. The store is, for example, a retail store that sells clothes, foods, or the like. In the present example embodiment, it is assumed to perform settlement by the settlement processing device 100, by using a medium recording registration biometric information that is biometric authentication information registered to identify a customer and settlement information used to settle a purchased product by the customer. In the present example embodiment, the medium is a terminal such as a smartphone carried by a customer, an integrated circuit (IC) card such as a point card, paper, or the like. In a case where the medium is paper, code information in which the registration biometric information and the settlement information are embedded is printed.

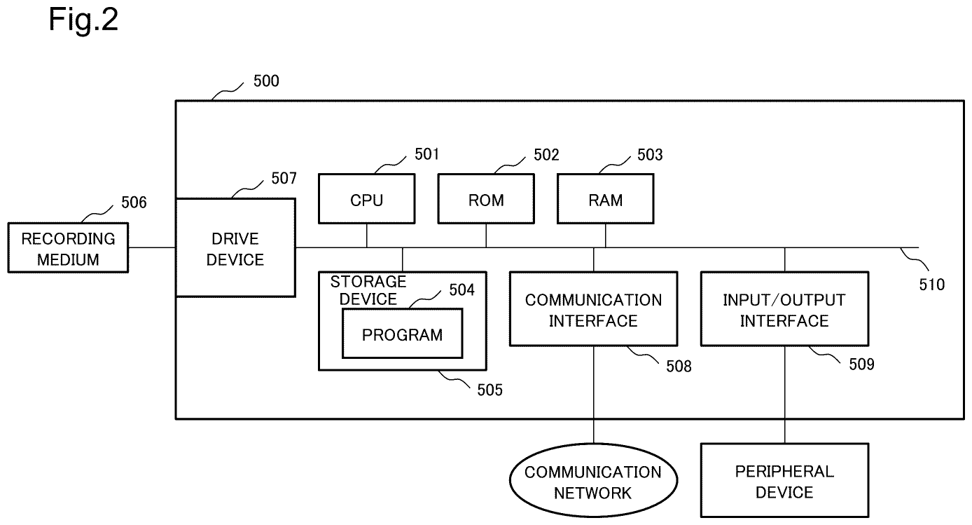

With reference to FIG. 1, the settlement processing device 100 includes a purchase information acquisition unit 101, a registration information acquisition unit 102, a collation information acquisition unit 103, a collation unit 104, and a settlement unit 105. FIG. 2 is a diagram illustrating an example of a hardware configuration of the settlement processing device 100 according to the first example embodiment of the present disclosure achieved by a computer device 500 including a processor. As illustrated in FIG. 2, the settlement processing device 100 includes a central processing unit (CPU) 501, memories such as a read only memory (ROM) 502 or a random access memory (RAM) 503, a storage device 505, such as a hard disk, that stores a program 504, a communication interface 508 for network connection, and an input/output interface 509 via which data is to be inputted or outputted. In the first example embodiment, the settlement processing device 100 is connected to each component via a bus 510. The settlement processing device 100 according to the first example embodiment illustrated in FIG. 1 can also be configured by cloud computing or the like.

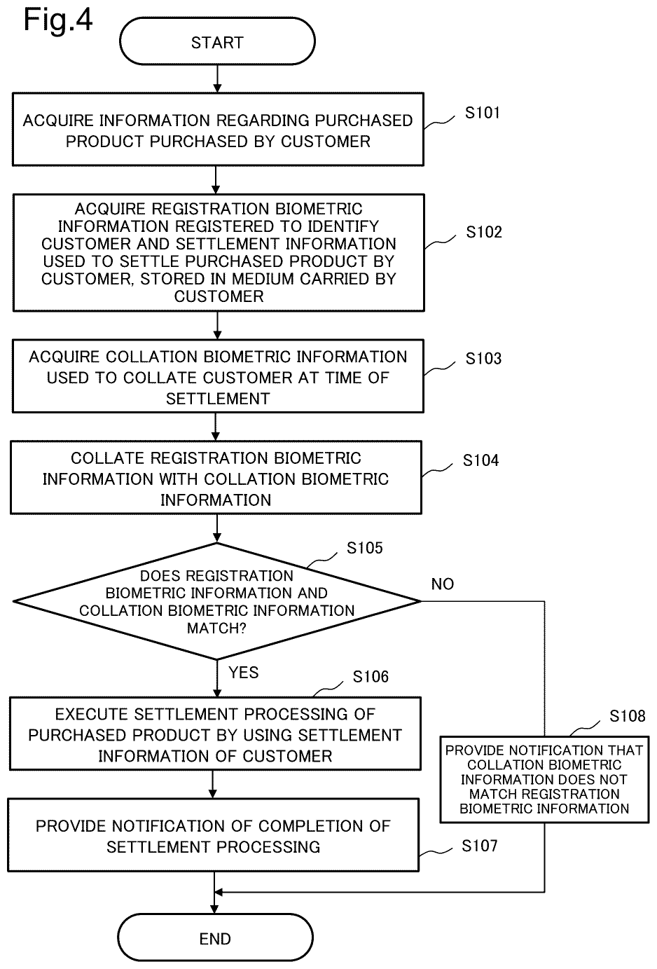

The CPU 501 activates an operating system to control the entire settlement processing device 100 according to the first example embodiment of the present invention. In addition, the CPU 501 reads programs and data from a recording medium 506 mounted in, for example, a drive device 507 or the like onto a memory. The CPU 501 functions as the purchase information acquisition unit 101, the registration information acquisition unit 102, the collation information acquisition unit 103, the collation unit 104, the settlement unit 105, and a part thereof in the first example embodiment and executes processing or a command in the flowchart illustrated in FIG. 4 to be described later based on a program.

Examples of the recording medium 506 include an optical disc, a flexible disk, a magnetic optical disc, an external hard disk, and a semiconductor memory. A semiconductor memory or the like, which is one of recording media, is a non-volatile storage device and records programs therein. The programs may be downloaded from an external computer (not illustrated) connected to a communication network.

As described above, the first example embodiment illustrated in FIG. 1 is achieved by computer hardware illustrated in FIG. 2. However, means for achieving each unit included in the settlement processing device 100 in FIG. 1 is not limited to the above-described configuration. The settlement processing device 100 may be achieved by one physically coupled apparatus, or may be achieved by a system by connecting two or more physically separated apparatuses in a wired or wireless manner and including the plurality of these apparatuses.

The purchase information acquisition unit 101 is means for acquiring information regarding a purchased product purchased by a customer. In the present example embodiment, in a case where a RFID tag is attached to the purchased product in advance, the purchase information acquisition unit 101 acquires information regarding the purchased product read by a RFID reader. The RFID reader may be included in the settlement processing device 100 or may be included in product housing means such as a shopping basket or a cart used by the customer. In a case where the customer scans the purchased product on an application program for shopping, the purchase information acquisition unit 101 may acquire information regarding the purchased product scanned by the customer via the application program. The purchase information acquisition unit 101 outputs the acquired information regarding the purchased product to the settlement unit 105.

The registration information acquisition unit 102 is means for acquiring the registration biometric information that is the biometric authentication information used to identify the customer and the settlement information, recorded in a medium carried by the customer. In the present example embodiment, the registration biometric information and the settlement information are stored in a contactless IC chip of the medium carried by the customer, and the registration information acquisition unit 102 acquires the information stored in the contactless IC chip by using a contactless IC card reader. The registration information acquisition unit 102 outputs the acquired registration biometric information to the collation unit 104 and outputs the settlement information to the settlement unit 105.

The collation information acquisition unit 103 is means for acquiring collation biometric information used to collate a customer at the time of settlement. The collation information acquisition unit 103 acquires the biometric authentication information of the same type as the registration biometric information. As the registration biometric information, any biometric authentication information such as face authentication information, iris authentication information, fingerprint authentication information, or vein authentication information that can identify a customer is used. For example, in a case where the registration biometric information is the face authentication information, the collation information acquisition unit 103 includes a camera and acquires data of a feature amount of a face of a customer at the time of settlement. The collation information acquisition unit 103 outputs the acquired collation biometric information to the collation unit 104.

The collation unit 104 is means for collating the registration biometric information with the collation biometric information. The collation unit 104 collates and compares data of a feature amount of the registration biometric information with data of a feature amount of the collation biometric information by a known method. However, if the biometric authentication information of the customer can be collated from the two pieces of information including the registration biometric information and the collation biometric information, collation may be performed using data other than the data of the feature amount. The collation unit 104 outputs the collation result to the settlement unit 105.

In a case where the registration biometric information matches the collation biometric information, the settlement unit 105 performs settlement of the purchased product by using the settlement information of the customer. After performing the settlement, the settlement unit 105 may transmit a message for providing notification of completion of the settlement or an electronic receipt including information regarding the purchased product, information regarding a payment amount, or the like, to a terminal carried by the customer.

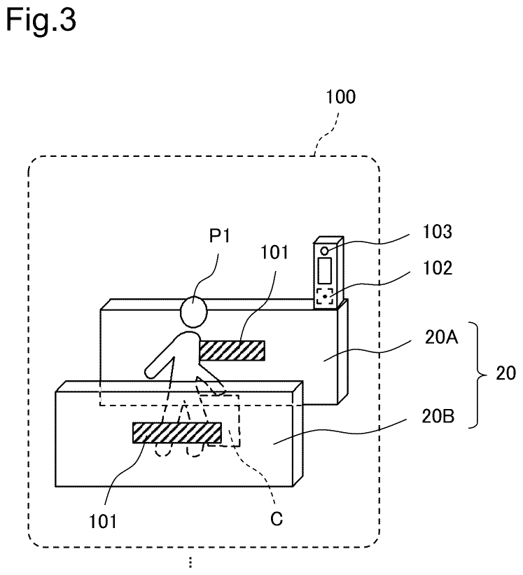

FIG. 3 is a diagram for explaining an example of the settlement processing device 100. As illustrated in FIG. 3, the settlement processing device 100 may be incorporated into a part of a gate 20. The gate 20 includes the purchase information acquisition unit 101 including the RFID reader for reading the RFID tag included in each purchased product purchased by the customer who is passing through, the registration information acquisition unit 102 including the contactless IC card reader that reads the registration biometric information and the settlement information recorded in the medium carried by the customer, and the collation information acquisition unit 103 including the camera that acquires the collation biometric information. The collation unit 104 and the settlement unit 105 may be included in the gate 20 or may be included in a server device (not illustrated).

In the example of the settlement processing device 100 in FIG. 3, the purchase information acquisition unit 101 is provided in side wall portions (portions indicated by references 20A and 20B in FIG. 3) of the gate 20. The side wall portions 20A and 20B of the gate 20 are provided with a width through which product housing means C and the customer can pass at the same time. The purchase information acquisition unit 101 communicates with the RFID tag attached to each purchased product and acquires identification information of the product stored in a recording region of each RFID tag. The registration information acquisition unit 102 including the contactless IC card reader acquires the registration biometric information and the settlement information from the contactless IC chip of the medium carried by the customer. The collation information acquisition unit 103 including the camera acquires the collation biometric information of the customer.

In the example of the settlement processing device 100 in FIG. 3, in a case where the registration biometric information and the collation biometric information match and authentication processing is succeeded, the customer is permitted to pass through the gate 20. For example, in a case where the authentication processing is succeeded, a door (not illustrated) on an entrance side of the gate 20 is opened. In addition, in a case where a notification device (a speaker, a display, a lamp, or the like which is not illustrated) is provided in the gate 20 and the authentication processing is succeeded, the notification device may be configured to audibly or visually provide notification that the passage is permitted.

The configuration of the settlement processing device 100 is not limited to the example in FIG. 3. The settlement processing device 100 may be provided as a single apparatus different from the gate 20. For example, the acquisition of the registration biometric information by the registration information acquisition unit 102, the acquisition of the collation biometric information by the collation information acquisition unit 103, and the collation by the collation unit 104 may include BM1300−W22Q (face authentication+two-dimensional code correspondence model) manufactured by NEC Platforms, Ltd.

FIG. 4 is a flowchart illustrating an outline of an operation of the settlement processing device 100 according to the first example embodiment. Processing according to this flowchart may be executed based on program control executed by the processor described above.

First, the purchase information acquisition unit 101 acquires the information regarding the purchased product purchased by the customer (step S101). Next, the registration information acquisition unit 102 acquires the registration biometric information that is the biometric authentication information used to identify the customer and the settlement information used to settle the purchased product by the customer, recorded in the medium carried by the customer (step S102). Next, the collation information acquisition unit 103 acquires the collation biometric information used to collate the customer at the time of settlement (step S103). Next, the collation unit 104 collates the registration biometric information with the collation biometric information (step S104). In a case where the registration biometric information matches the collation biometric information (step S105; YES), the settlement unit 105 executes settlement processing of the purchased product by using the settlement information of the customer (step S106) and provides notification of completion of the settlement processing (step S107). On the other hand, in a case where the registration biometric information does not match the collation biometric information (step S105; NO), the settlement unit 105 provides notification that the collation biometric information does not match the registration biometric information (step S108). As described above, the settlement processing device 100 ends the settlement processing.

In the settlement processing device 100 according to the present example embodiment, the collation unit 104 collates the registration biometric information that is the biometric authentication information used to identify the customer with the collation biometric information used to collate the customer at the time of settlement, stored in the medium carried by the customer. In a case where the registration biometric information matches the collation biometric information, the settlement unit 105 performs the settlement of the purchased product by using the settlement information recorded in the medium. As a result, the settlement in the store can be simplified, without providing the biometric authentication information that is personal information, to a third party such as a store or a settlement agent.

### Second Example Embodiment

Next, a second example embodiment of the present disclosure will be described in detail with reference to the drawings. In an information processing system 11 according to the present example embodiment, a biometric information registration device 110 and a settlement processing device 210 are connected via a network.

Hereinafter, description of content overlapping with the above description will be omitted to the extent that the description of the present example embodiment is not unclear. As in the computer device illustrated in FIG. 2, the function of each component in each example embodiment of the present disclosure can be achieved not only by hardware but also by a computer device or software based on program control.

### (Biometric Information Registration Device 110)

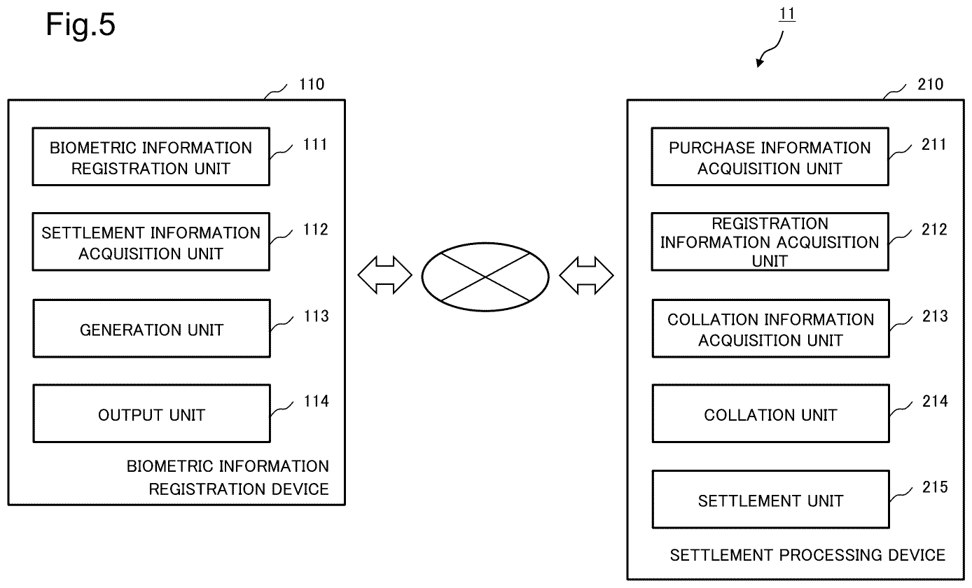

The biometric information registration device 110 is a device that registers biometric authentication information of a customer used to perform settlement of a purchased product by the customer who visits a store and is provided, for example, near an entrance of the store. Referring to FIG. 5, the biometric information registration device 110 includes a biometric information registration unit 111, a settlement information acquisition unit 112, a generation unit 113, and an output unit 114.

The biometric information registration unit 111 is means for registering registration biometric information that is the biometric authentication information used to identify the customer. The biometric information registration unit 111 has a function for registering the biometric authentication information and has a function for registering any biometric authentication information that can identify the customer such as face authentication information, iris authentication information, fingerprint authentication information, or vein authentication information. In a case of registering the face authentication information, the biometric information registration unit 111 includes a camera and acquires data of a feature amount of a face of the customer.

The settlement information acquisition unit 112 is means for acquiring settlement information used to settle the purchased product. For example, the settlement information acquisition unit 112 acquires the settlement information such as credit card information of the customer registered on an application program for settlement. As a method for acquiring the settlement information, a known method is used, and the settlement information acquisition unit 112 acquires the settlement information, for example, by reading a screen in which the settlement information is two-dimensionally coded on the application program. The settlement information acquisition unit 112 may read a screen in which a customer ID associated with the settlement information is embedded in a two-dimensional code. In this case, a settlement unit 215 to be described later acquires the settlement information associated with the customer ID from a server device that stores customer information.

The generation unit 113 is means for generating code information in which the registration biometric information and the settlement information are embedded. The code information is not particularly limited as long as the code information is information for identifying the biometric authentication information and the settlement information and includes numbers, symbols, information obtained by two-dimensionally coding these pieces of information, or the like. In the present example embodiment, the generation unit 113 may generate code information that is valid for a predetermined period. The predetermined period may be, for example, a period determined in advance or a period that satisfies a predetermined condition such as during a customer stays in a store. The generation unit 113 outputs the generated code information to the output unit 114.

The output unit 114 is means for outputting the generated code information. The output unit 114 may print the code information on paper by a printer. The output unit 114 may write the code information in a recording region of the medium carried by the customer.

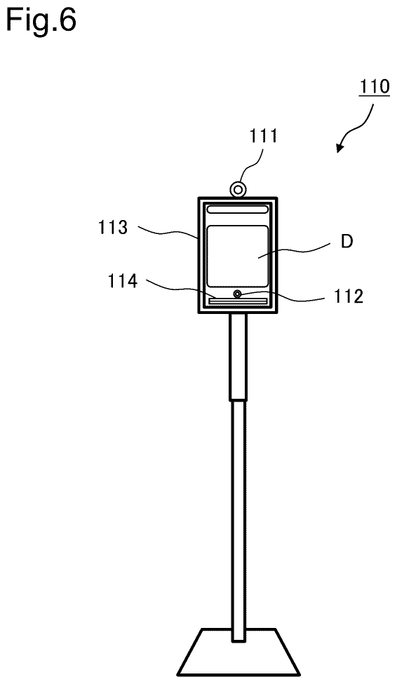

FIG. 6 is a diagram for explaining an example of the biometric information registration device 110. As illustrated in FIG. 6, the biometric information registration device 110 includes the biometric information registration unit 111 including a camera that registers the registration biometric information that is the biometric authentication information used to identify the customer, the settlement information acquisition unit 112 including a camera that reads a screen in which the settlement information of the customer is two-dimensionally coded, the generation unit 113 that generates the code information in which the registration biometric information and the settlement information are embedded, in the biometric information registration device 110, the output unit 114 including the printer, and an operation screen D. The configuration of the biometric information registration device 110 is not limited to the example in FIG. 6.

### (Settlement Processing Device 210)

Next, the settlement processing device 210 will be described focusing on portions different from those of the settlement processing device 100 according to the first example embodiment. The settlement processing device 210 includes a purchase information acquisition unit 211, a registration information acquisition unit 212, a collation information acquisition unit 213, a collation unit 214, and the settlement unit 215, and the purchase information acquisition unit 211, the collation information acquisition unit 213, the collation unit 214, and the settlement unit 215 are similar to the related components of the first example embodiment.

In the first example embodiment, the registration information acquisition unit 102 has acquired the registration biometric information and the settlement information, recorded in the medium carried by the customer. On the other hand, the registration information acquisition unit 212 acquires the registration biometric information and the settlement information embedded in the code information. In a case where the code information is printed on paper, the registration information acquisition unit 212 acquires the registration biometric information and the settlement information, for example, by reading printed information with the camera. In a case where the code information is recorded in the IC card carried by the customer or the contactless IC chip of the terminal, the registration biometric information and the settlement information are acquired by using a contactless IC reader.

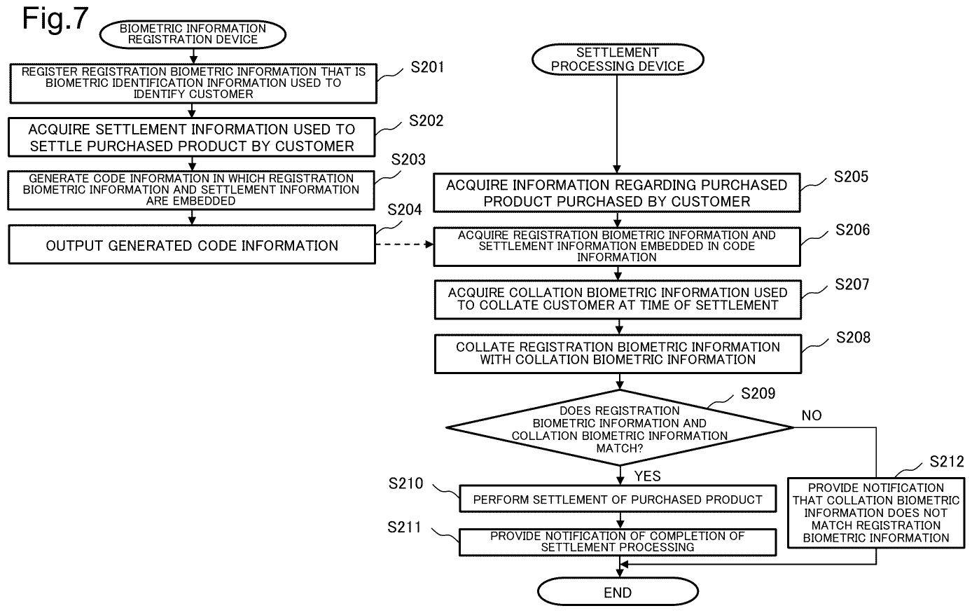

FIG. 7 is a flowchart illustrating an outline of an operation of the information processing system 11 according to the second example embodiment. Processing according to this flowchart may be executed based on program control executed by the processor described above.

FIG. 7 is a flowchart illustrating the operation of the information processing system 11 according to the second example embodiment.

First, in the biometric information registration device 110, the biometric information registration unit 111 registers the registration biometric information that is the biometric authentication information used to identify the customer (step S201). Next, the settlement information acquisition unit 112 acquires the settlement information used to settle the purchased product by the customer (step S202). Next, the generation unit 113 generates the code information in which the registration biometric information and the settlement information are embedded (step S203). Next, the output unit 114 outputs the code information (step S204).

In the settlement processing device 210, first, the purchase information acquisition unit 211 acquires information regarding the purchased product purchased by the customer (step S205). Next, the registration information acquisition unit 212 acquires the registration biometric information and the settlement information embedded in the code information (step S206). Next, the collation information acquisition unit 213 acquires collation biometric information used to collate the customer at the time of settlement (step S207). Next, the collation unit 214 collates the registration biometric information with the collation biometric information (step S208). In a case where the registration biometric information matches the collation biometric information (step S209; YES), the settlement unit 215 executes settlement of the purchased product by using the settlement information of the customer (step S210) and provides notification of completion of the settlement processing (step S211). Next, on the other hand, in a case where the registration biometric information does not match the collation biometric information (step S209; NO), the settlement unit 215 provides notification that the collation biometric information does not match the registration biometric information (step S212). As described above, the information processing system 11 ends the processing.

In the present example embodiment, in the biometric information registration device 110, the output unit 114 outputs the code information in which the registration biometric information and the settlement information are embedded. In this case, for example, even if a medium recording personal information such as the biometric authentication information is not carried, settlement can be performed, without providing the personal information to a third party.

### Modification of Second Example Embodiment

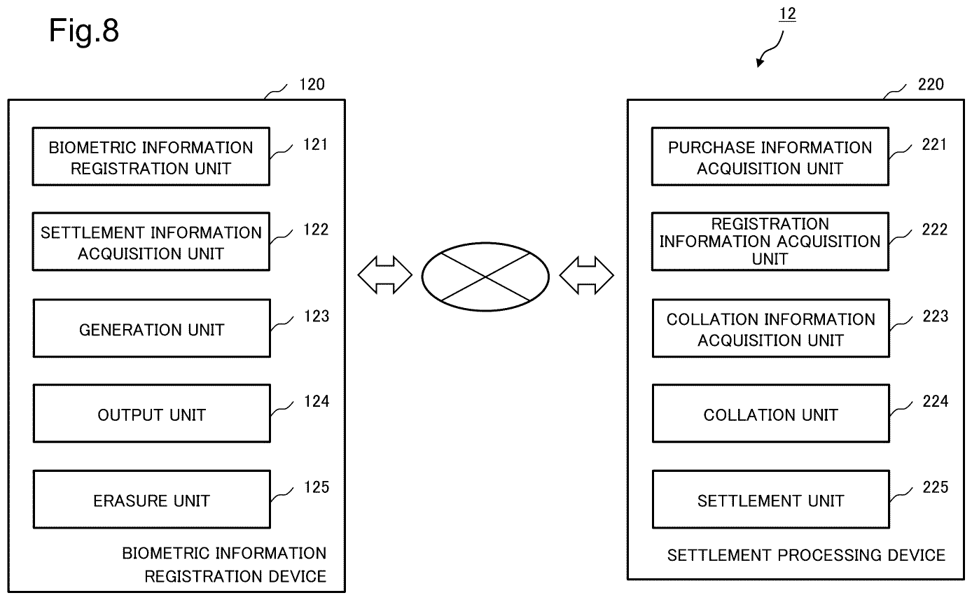

FIG. 8 is a block diagram illustrating a configuration of an information processing system 12 according to a modification of the second example embodiment. Referring to FIG. 8, a biometric information registration device 120 includes a biometric information registration unit 121, a settlement information acquisition unit 122, a generation unit 123, an output unit 124, and an erasure unit 125.

In the modification of the second example embodiment, the output unit 124 writes the code information in product housing means used by the customer. Specifically, the product housing means includes a RFID tag, and the output unit 124 writes the code information in the RFID tag by using a RFID writer. When detecting that the customer has finished shopping, the erasure unit 125 erases the code information written in the product housing means. For example, the erasure unit 125 detects that the customer has finished shopping in a case where the product housing means moves to a collection place. In addition, the erasure unit 125 may detect that the shopping has finished in a case where the product housing means has passed through a gate. The erasure unit 125 detects that shopping of the customer ends, by detecting radio waves or infrared rays emitted from a beacon or the like provided in the product housing means by using a sensor provided at the collection place or the gate.

In the modification of the second example embodiment, components other than the output unit 124 and the erasure unit 125 are similar to related components of the second example embodiment.

In the present example embodiment, the output unit 124 writes the code information in the product housing means used by the customer. In this case, because the product housing means used by the customer at the time of shopping is used to record the personal information such as the biometric authentication information, convenience of the customer can be enhanced.

While the present disclosure has been particularly shown and described with reference to example embodiments thereof, the present disclosure is not limited to the these example embodiments. It will be understood by those of ordinary skill in the art that various changes in form and details may be made therein without departing from the spirit and scope of the present disclosure as defined by the claims. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of the flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### (Supplementary Note 1)

A settlement processing device including:
purchase information acquisition means for acquiring information regarding a purchased product purchased by a customer;
registration information acquisition means for acquiring registration biometric information that is biometric authentication information used to identify the customer and settlement information used to settle the purchased product by the customer, recorded in a medium carried by the customer;
collation information acquisition means for acquiring collation biometric information used to collate the customer at the time of settlement;
collation means for collating the registration biometric information with the collation biometric information; and
settlement means for performing settlement of the purchased product by using the settlement information, in a case where the registration biometric information and the collation biometric information match.

### (Supplementary Note 2)

The settlement processing device according to supplementary note 1, in which the registration information acquisition means and the collation information acquisition means are incorporated into a gate through which the customer passes.

### (Supplementary Note 3)

The settlement processing device according to supplementary note 1 or 2, in which
a RFID tag in which product information is written is included in each purchased product, and
the purchase information acquisition means acquires information regarding the purchased product written in the RFID tag, by a RFID reader provided in the gate through which the customer passes.

### (Supplementary Note 4)

An information processing system including:
the settlement processing device according to any one of supplementary notes 1 to 3; and
a medium recording registration biometric information that is biometric authentication information used to identify a customer and settlement information used to settle a purchased product by the customer.

### (Supplementary Note 5)

A biometric information registration device including:
biometric information registration means for registering registration biometric information that is biometric authentication information used to identify a customer;
settlement information acquisition means for acquiring settlement information used to settle a purchased product by the customer;
generation means for generating code information in which the registration biometric information and the settlement information are embedded; and
output means for outputting the code information.

### (Supplementary Note 6)

The biometric information registration device according to supplementary note 5, in which the generation means generates code information that is valid for a predetermined period.

### (Supplementary Note 7)

The biometric information registration device according to supplementary note 5 or 6, in which the output means prints the code information on paper and outputs the code information.

### (Supplementary Note 8)

The biometric information registration device according to any one of supplementary notes 5 to 7, in which
the output means writes the code information in product housing means used by the customer, and
the biometric information registration device further including:
erasure means for erasing the written code information, in a case of detecting that shopping of the customer ends.

### (Supplementary Note 9)

An information processing system including:
a biometric information registration device; and
the settlement processing device according to any one of supplementary notes 1 to 3, in which
the biometric information registration device includes
biometric information registration means for registering registration biometric information that is biometric authentication information used to identify a customer,
settlement information acquisition means for acquiring settlement information used to settle a purchased product by the customer,
generation means for generating code information in which the registration biometric information and the settlement information are embedded, and
output means for outputting the code information.

### (Supplementary Note 10)

An information processing system including:
the biometric information registration device according to any one of supplementary notes 5 to 8; and
a settlement processing device, in which
the settlement processing device includes
purchase information acquisition means for acquiring information regarding a purchased product purchased by a customer,
registration information acquisition means for acquiring registration biometric information that is biometric authentication information used to identify the customer and settlement information used to settle the purchased product by the customer, recorded in a medium carried by the customer,
collation information acquisition means for acquiring collation biometric information used to collate the customer at the time of settlement,
collation means for collating the registration biometric information with the collation biometric information, and
settlement means for performing settlement of the purchased product by using the settlement information, in a case where the registration biometric information and the collation biometric information match.

### (Supplementary Note 11)

A settlement processing method performed by a computer, including:
acquiring information regarding a purchased product purchased by a customer;
acquiring registration biometric information that is biometric authentication information used to identify the customer and settlement information used to settle the purchased product by the customer, recorded in a medium carried by the customer;
acquiring collation biometric information used to collate the customer at the time of settlement;
collating the registration biometric information with the collation biometric information; and
performing settlement of the purchased product by using the settlement information used to settle the purchased product by the customer, in a case where the registration biometric information and the collation biometric information match.

### (Supplementary Note 12)

A biometric information registration method performed by a computer, including:
registering registration biometric information that is biometric authentication information used to identify a customer;
acquiring settlement information used to settle a purchased product by the customer;
generating code information in which the registration biometric information and the settlement information are embedded; and
outputting the code information.

### (Supplementary Note 13)

An information processing method performed by a computer, including:
registering registration biometric information that is biometric authentication information used to identify a customer;
acquiring settlement information used to settle a purchased product by the customer;
generating code information in which the registration biometric information and the settlement information are embedded;
outputting the code information;
acquiring information regarding the purchased product purchased by the customer;
acquiring the registration biometric information and the settlement information embedded in the code information;
acquiring collation biometric information that is biometric authentication information used to collate the customer at the time of settlement;
collating the registration biometric information with the collation biometric information; and
performing settlement of the purchased product by using the settlement information embedded in the code information, in a case where the registration biometric information and the collation biometric information match.

### (Supplementary Note 14)

A recording medium storing a program for causing a computer to execute processing including:
acquiring information regarding a purchased product purchased by a customer;
acquiring registration biometric information that is biometric authentication information used to identify the customer and settlement information used to settle the purchased product by the customer, recorded in a medium carried by the customer;
acquiring collation biometric information used to collate the customer at the time of settlement;
collating the registration biometric information with the collation biometric information; and
performing settlement of the purchased product by using the settlement information used to settle the purchased product by the customer, in a case where the registration biometric information and the collation biometric information match.

### (Supplementary Note 15)

A recording medium storing a program for causing a computer to execute processing including:
registering registration biometric information that is biometric authentication information used to identify a customer;
acquiring settlement information used to settle a purchased product by the customer;
generating code information in which the registration biometric information and the settlement information are embedded; and
outputting the code information.

### (Supplementary Note 16)

A recording medium storing a program for causing a computer to execute processing including:
registering registration biometric information that is biometric authentication information used to identify a customer;
acquiring settlement information used to settle a purchased product by the customer;
generating code information in which the registration biometric information and the settlement information are embedded;
outputting the code information;
acquiring information regarding the purchased product purchased by the customer;
acquiring the registration biometric information and the settlement information embedded in the code information;
acquiring collation biometric information that is biometric authentication information used to collate the customer at the time of settlement;
collating the registration biometric information with the collation biometric information; and
performing settlement of the purchased product by using the settlement information embedded in the code information, in a case where the registration biometric information and the collation biometric information match.

### REFERENCE SIGNS LIST

11, 12 information processing system
100, 210, 220 settlement processing device
101, 211, 221 purchase information acquisition unit
102, 212, 222 registration information acquisition unit
103, 213, 223 collation information acquisition unit
104, 214, 224 collation unit
105, 215, 225 settlement unit
110, 120 biometric information registration device
111, 121 biometric information registration unit
112, 122 settlement information acquisition unit
113, 123 generation unit
114, 124 output unit
125 erasure unit
500 computer device
501 CPU
502 ROM
503 RAM
504 program
505 storage device
506 recording medium
507 drive device
508 communication interface
509 input/output interface
510 bus

What is claimed is:

1. A settlement processing device comprising:
one or more memories storing instructions; and
one or more processors configured to execute the instructions to:
acquire information regarding a purchased product purchased by a customer;
acquire registration biometric information that is biometric authentication information used to identify the customer and settlement information used to settle the purchased product by the customer, recorded in a medium carried by the customer;
acquire collation biometric information used to collate the customer at the time of settlement;
collate the registration biometric information with the collation biometric information; and
perform settlement of the purchased product by using the settlement information, in a case where the registration biometric information and the collation biometric information match.

2. The settlement processing device according to claim 1, wherein the one or more processors configured to execute the instructions to acquire the registration biometric information and to acquire the collation biometric information are incorporated into a gate through which the customer passes.

3. The settlement processing device according to claim 1, wherein
a Radio Frequency Identification (RFID) tag in which product information is written is included in each purchased product, and
the one or more processors are further configured to execute the instructions to acquire information regarding the purchased product written in the RFID tag, by a RFID reader provided in the gate through which the customer passes.

4. An information processing system comprising:;
the settlement processing device according to claim 1 and
a non-transitory medium recording registration biometric information that is biometric authentication information used to identify a customer and settlement information used to settle a purchased product by the customer.

5. A biometric information registration device comprising:
one or more memories storing instructions; and
one or more processors are configured to execute the instructions to:
register registration biometric information that is biometric authentication information used to identify a customer;
acquire settlement information used to settle a purchased product by the customer;
generate code information in which the registration biometric information and the settlement information are embedded; and
output the code information.

6. The biometric information registration device according to claim 5, wherein the one or more processors are further configured to execute the instruction to generate code information that is valid for a predetermined period.

7. The biometric information registration device according to claim 5, wherein the one or more processors are further configured to execute the instructions to print the code information on paper and output the code information.

8. The biometric information registration device according to claim 5,
wherein the one or more processors are further configured to execute the instructions to:
write the code information in product housing unit used by the customer; and
erase the written code information, in a case of detecting that shopping of the customer ends.

9. An information processing system comprising:
a biometric information registration device; and
the settlement processing device according to claim 1, wherein
the biometric information registration device includes:
one or more memories storing instructions; and
one or more processors configured to execute the instructions to:
register registration biometric information that is biometric authentication information used to identify a customer,
acquire settlement information used to settle a purchased product by the customer,
generate code information in which the registration biometric information and the settlement information are embedded, and
output the code information.

10. An information processing system comprising:
the biometric information registration device according to claim 5; and
a settlement processing device, wherein
the settlement processing device includes:
one or more memories storing instructions; and
one or more processors configured to execute the instructions to:
acquire information regarding a purchased product purchased by a customer,
acquire registration biometric information that is biometric authentication information used to identify the customer and settlement information used to settle the purchased product by the customer, recorded in a medium carried by the customer,
acquire collation biometric information used to collate the customer at the time of settlement,
collate the registration biometric information with the collation biometric information, and
perform settlement of the purchased product by using the settlement information, in a case where the registration biometric information and the collation biometric information match.

11. A settlement processing method performed by a computer, comprising:
acquiring information regarding a purchased product purchased by a customer;
acquiring registration biometric information that is biometric authentication information used to identify the customer and settlement information used to settle the purchased product by the customer, recorded in a medium carried by the customer;
acquiring collation biometric information used to collate the customer at the time of settlement;
collating the registration biometric information with the collation biometric information; and
performing settlement of the purchased product by using the settlement information used to settle the purchased product by the customer, in a case where the registration biometric information and the collation biometric information match.

12-16. (canceled)
